(19) United States
(12) Patent Application Publication
(10) Pub. No.: US 2011/0005367 A1
(43) Pub. Date: Jan. 13, 2011

(54) DEVICE AND METHOD TO DISPLAY FINGERBOARD OF MOBILE VIRTUAL GUITAR

(76) Inventors: Jay-Yeob Hwang, Gyeonggi-do (KR); Giho Yang, Seoul (KR)

Correspondence Address: Jae Y. Park, Kile, Park, Goekjian, Reed & McManus, PLLC, 1200 New Hampshire Ave. NW, Suite 570, Washington, DC, 20036, US

(21) Appl. No.: 12/920,302

(22) PCT Filed: Mar. 2, 2009
(86) PCT No.: PCT/KR09/01008

§ 371 Date: Aug. 30, 2010

(30) Foreign Application Priority Data
Feb. 28, 2008 (KR) 10-2008-0018624
Sep. 16, 2008 (KR) 10-2008-0090641

(51) Int. Cl. G10D 3/06

(52) U.S. Cl. 84/314 R

(57) ABSTRACT

Disclosed are a device and a method to display a fingerboard of a mobile vibration guitar in a mobile device, such as a cellular phone. A mobile device screen, such as a cellular phone screen, is too small to display a long fingerboard without causing difficulties when playing. The present invention is provided to display a whole fingerboard within a small screen of a mobile device without any difficulties when playing. A player may play the mobile virtual guitar by applying various playing techniques used to play the real guitar. The fingerboard is directly played with fingers on a mobile screen that is a touch screen supporting a multi-touch operation. Since a movement recognition sensor is attached inside the mobile device, and the fingerboard on the screen is synchronized with the longitudinal movement of the fingers, the fingerboard may move in the same direction and at the same speed as the movement of the fingers. The mobile device is equipped with the movement recognition sensor and the touch screen supporting the multi-touch operation. The fingerboard is displayed on the touch screen so that the player may play the guitar by pressing chords displayed on the touch screen with fingers. The touch screen displays the fingerboard according to the speed and movement of the fingers as the movement recognition sensor senses the fingers collinearly moved with the fingerboard. The whole actual fingerboard of the guitar is naturally displayed on a screen of a mobile device, such as a cellular phone having a small screen without an auxiliary device, and the player may play the mobile virtual guitar by applying various playing techniques used to play the real guitar.

### TECHNICAL FIELD

The present invention relates to a mobile virtual guitar. More particularly, the present invention relates to a device and a method to display a fingerboard of a mobile vibration guitar on a small screen of a mobile device.

### BACKGROUND ART

The present invention utilizes a touch screen and a motion recognition technology.

### DISCLOSURE

### Technical Problem

Actually, a mobile device screen, such as a cellular phone screen, is too small to display a long fingerboard without causing difficulties when playing.

Accordingly, the present invention is provided to display a whole fingerboard within a small screen of a mobile device without any difficulties when playing.

In addition, according to the present invention, a player can play a mobile virtual guitar by applying various playing techniques used to play the real guitar.

### Technical Solution

The fingerboard is directly played with fingers on a mobile screen that is a touch screen supporting a multi-touch operation. Since a movement recognition sensor is attached inside the mobile device, and the fingerboard on the screen is synchronized with the longitudinal movement of the fingers, the fingerboard can move in the same direction and at the same speed as the movement of the fingers.

The mobile device is equipped with the movement recognition sensor and the touch screen supporting the multi-touch operation. In addition, the fingerboard of a guitar is displayed on the touch screen so that the player can play the guitar by pressing chords displayed on the touch screen with fingers. The touch screen displays the fingerboard according to the speed and movement of the fingers as the movement recognition sensor senses the fingers collinearly moved with the fingerboard.

### ADVANTAGEOUS EFFECTS

According to the present invention, the whole actual fingerboard of the guitar can be naturally displayed on a screen of a mobile device, such as a cellular phone having a small screen without an auxiliary device, and the player can play a mobile virtual guitar by applying various playing techniques used to play a real guitar.

### DESCRIPTION OF DRAWINGS

FIG. 1 is a view showing a fingerboard being moved corresponding to the movement of a fingerboard display apparatus according to the present invention;

FIG. 2 is a view showing a fingerboard which is fixed as a player presses the fingerboard;

FIG. 3 is a view showing a fingerboard being moved as a player presses a sliding button in a state in which the user presses the fingerboard;

FIG. 4 is a block view showing the structure of the present invention; and

FIG. 5 is a flowchart showing the procedure for moving the fingerboard according to the present invention.

### BEST MODE

### Mode for Invention

In order to solve the problem occurring in the prior art, the present invention provides a touch screen supporting a multi-touch operation and a movement recognition sensor.

For the purpose of convenience, the following description will be made with reference to a casein which a right-handed person plays the guitar.

In general, a person plays a guitar by touching or beating chords of the guitar using a right hand while gripping a fingerboard using a left hand. Various playing techniques for a mobile virtual guitar may exist, but it is difficult to grip the fingerboard of the mobile virtual guitar because a screen that displays the fingerboard is too large in a general personal computer (PC) and too small in a mobile device. In addition, a touch screen supporting a multi-touch operation is required to allow the player to press guitar chords. However, the above function is not supported in the PC.

The capacitance type touch screen can support the multi-touch operation. In this regard, the present invention displays the fingerboard of the guitar on the touch screen supporting the multi-touch operation such that the player can directly press the fingerboard with fingers similarly to the interface of the real guitar.

However, there is a problem in that the screen is too small to display the long fingerboard. In order to solve this problem, the present invention employs a movement recognition sensor. Hereinafter, the present invention will be described with reference to accompanying drawings.

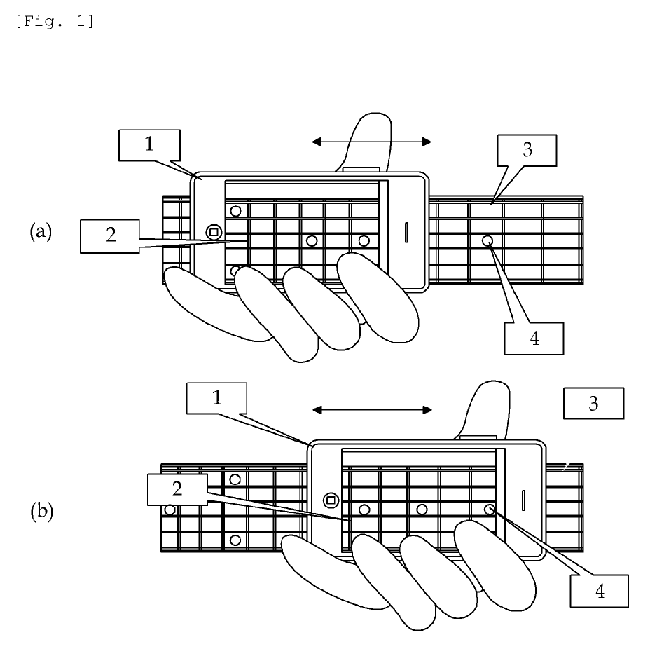

FIG. 1 is a view showing a fingerboard being moved corresponding to the movement of a fingerboard display apparatus according to the present invention.

A movement recognition sensor senses the movement of the fingerboard display apparatus 1, which is equipped with a touch screen 2 and longitudinally moves along the fingerboard. If it is determined that the fingerboard display apparatus 1 moves toward a higher fret, the touch screen 2 displays apart of the fingerboard corresponding to the higher fret in synchronization with the speed and movement of the fingerboard display apparatus 1. In contrast, if it is determined that the fingerboard display apparatus 1 moves toward a lower fret, the touch screen 2 displays a part of the fingerboard corresponding to the lower fret in synchronization with the speed and movement of the fingerboard display apparatus 1.

In FIG. 1, the fingerboard 3 illustrated outside the fingerboard display apparatus 1 represents the image of the fingerboard 3 which will be displayed on the touch screen as the fingerboard display apparatus 1 is moved. This image is illustrative purpose, and actually, this image is not seen to the naked eyes.

In a state in which the fingerboard display apparatus 1 is positioned at a place illustrated in FIG. 1a, if the player wants to display a part of the fingerboard marked with a first position mark 4, the player moves the fingerboard display apparatus 1 toward the first position mark 4 by taking the distance into consideration. At this time, the movement recognition sensor senses the movement of the fingerboard display apparatus 1 and transmits the movement data to a controller, so that the controller controls the touch screen to display the part of the fingerboard required by the player as shown in FIG. 1b.

When playing the guitar, the player may feel excitation. In this case, the player may shake or wave his/her body or may run from place to place. At this time, the movement recognition sensor senses the movement of the fingerboard display apparatus 1 so that an undesired part of the fingerboard may be displayed on the screen. In order to prevent this situation, the present invention classifies the motion patterns of the player. The fingerboard displayed on the screen may be changed by the player through two ways. The first one is that the player puts fingers off the fingerboard to display a new part of the fingerboard on the screen. The second one is that the player slidably moves the finger on the fingerboard while pressing a specific chord to cause the slur effect. The difference can be found from the position of the fingers. That is, the player puts the finger off the fingerboard in the first one, and puts the finger on the fingerboard in the second one. In general, the player frequently moves his/her body when playing the guitar. This may more frequently happen than the player plays the guitar to cause slur effect. According to the present invention, if the movement recognition sensor senses the longitudinal movement of the fingerboard display apparatus in a state in which the players puts the finger off the fingerboard, a new part of the fingerboard is displayed on the screen corresponding to the movement of the fingerboard display apparatus. In contrast, if the movement recognition sensor senses the longitudinal movement of the fingerboard display apparatus in a state in which the players puts the finger on the fingerboard, a new part of the fingerboard is not displayed on the screen. Exceptionally, in the case of the slur technique, the new part of the fingerboard must be displayed on the screen even if the player puts the finger on the fingerboard. Thus, a slur button is additionally provided in the fingerboard display apparatus.

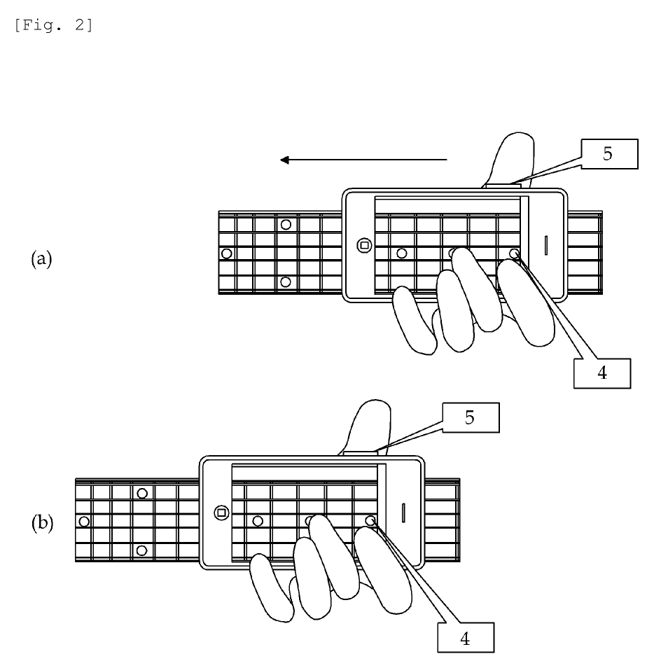

FIG. 2 is a view showing the fingerboard which is fixed as the player presses the fingerboard.

As shown in FIG. 2, although the player moves the fingerboard display apparatus in the left direction (see, (a) of FIG. 2), the fingerboard displayed on the screen is not changed (see, (b) of FIG. 2).

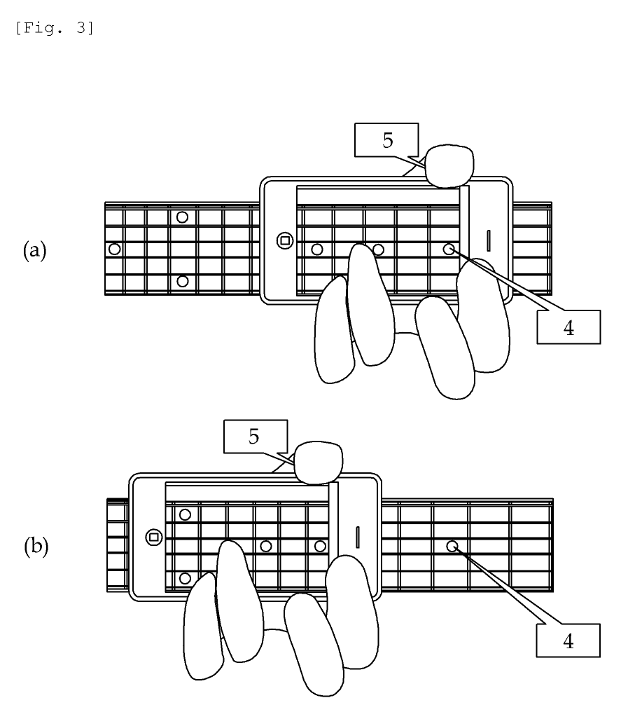

FIG. 3 is a view showing the fingerboard being moved as the player presses a sliding button in a state in which the user presses the fingerboard.

In FIG. 3, (a) represents the on-state of the slur button 5 and (b) represents the fingerboard display apparatus 1 moved in the left direction under the on-state of the slur button 5. As shown in FIG. 3, if the fingerboard display apparatus 1 is moved under the on-state of the slur button 5, a new part of the fingerboard is displayed in the screen even if the player puts the finger on the fingerboard. As a result, the sound corresponding to the new part of the fingerboard is output from the fingerboard display apparatus 1.

According to the present invention, it is not necessarily required for the movement recognition sensor to sense the movement direction and the speed of the fingerboard display apparatus 1. In general, the movement recognition sensor accommodated in the cellular phone may sense the gravity, so the movement recognition sensor may recognize the inclination degree of the cellular phone with respect to the axis of the earth. Based on such inclination information obtained by the movement recognition sensor, the fingerboard display apparatus 1 can display the fingerboard on the screen. For instance, if the right portion of the fingerboard display apparatus 1 is inclined upward, the fingerboard display apparatus 1 displays the right part of the fingerboard on the screen. In addition, if the left portion of the fingerboard display apparatus 1 is inclined upward, the fingerboard display apparatus 1 displays the left part of the fingerboard on the screen. In this case, the display range of the fingerboard must be previously set according to the inclination degree. For example, two new frets are displayed on the screen as the inclination degree increases by 5%. As another method, the display speed of the fingerboard on the screen may vary depending on the inclination degree, and the fingerboard displayed on the screen is not changed if the player puts the finger on the fingerboard. For instance, if the left portion of the fingerboard display apparatus is slightly inclined upward in a state in which the player puts all fingers off the fingerboard, the fingerboard moves slowly in the right direction so that the left part of the fingerboard is displayed on the screen. In addition, if the left portion of the fingerboard display apparatus is much inclined upward, the fingerboard moves fast in the right direction. In this state, if the player puts the finger on the fingerboard, the movement of the fingerboard is stopped.

In a state in which all fingers are put off the fingerboard, if the effective movement of the fingerboard display apparatus, which is defined as the movement above a predetermined range, and the movement direction of the fingerboard display apparatus are sensed, the player can play the guitar without causing difficulty even if the fingerboard is moved corresponding to the effective movement of the fingerboard display apparatus. If the player wants to move the fingerboard, the player slightly moves the fingerboard display apparatus, so that the fingerboard is moved in a predetermined speed. When the fret required by the player is displayed on the screen, the player puts the finger on the fret to stop the movement of the fingerboard. The “predetermined speed” can be classified into various levels according to the level of the effective movement. In addition, the predetermined speed can be programmed in such a manner that the fingerboard moves slowly in the early stage and gradually increases the movement speed.

Hereinafter, the structure of the present invention performing the above functions will be described.

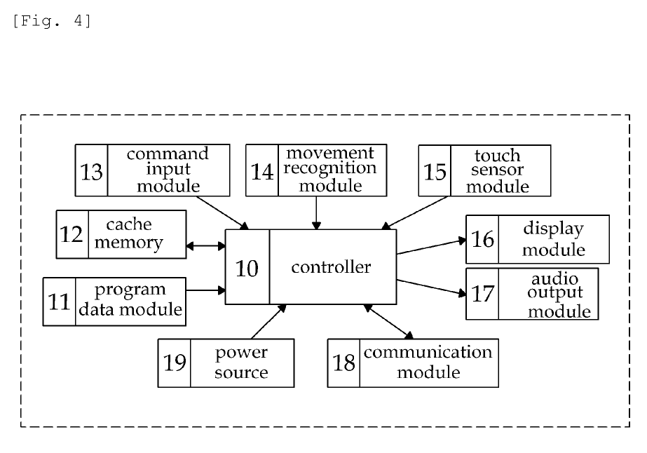

FIG. 4 is a block view showing the structure of the present invention.

The fingerboard display apparatus according to the present invention includes a controller 10 for controlling elements according to the predetermined program, a program data module 11 having program data to be loaded in the controller 10, a cache memory module 12 for temporally storing data required for executing the program of the controller 10, a command input module 13 for transmitting signals to the controller 10 to execute or stop the program or to adjust the volume, a movement recognition module 14 that senses movement information of the fingerboard display apparatus and sends the movement information to the controller 10, a touch sensor module 15 for transmitting multi-touch signals detected from a touch screen to the controller 10, a display module 16 for displaying the program proceeding status on the touch screen under the control of the controller 10, an audio output module 17 for outputting the sound of the guitar under the control of the controller 10, a communication module 18 communicated with external devices, and a power source module for supplying power to the fingerboard display apparatus.

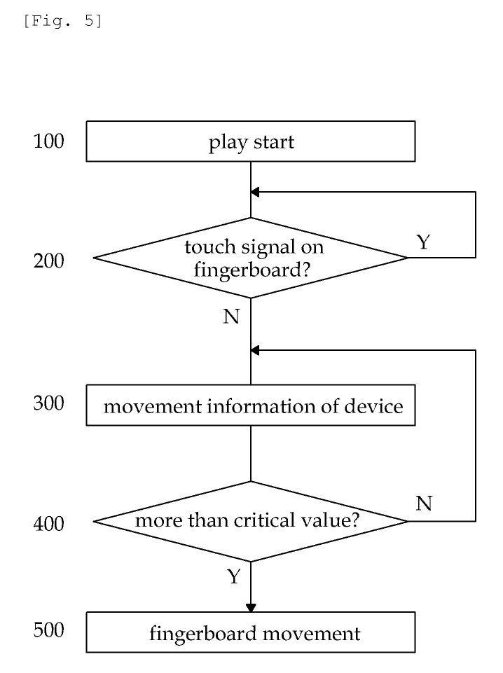

Hereinafter, the method for moving the fingerboard by using the movement information of the fingerboard display apparatus will be described in detail with reference to FIG. 5.

FIG. 5 is a flowchart showing the procedure for moving the fingerboard according to the present invention.

If the player turns on the fingerboard display apparatus, the program is executed (100). Then, the touch sensor module determines whether the touch signal to the fingerboard exists (200). If there is no touch signal to the fingerboard, the controller waits for the touch signal. In this state, the controller refers to the movement information of the fingerboard display apparatus transmitted from the movement recognition sensor (300). Then, the controller determines whether the movement information exceeds a critical value (effective movement) (400). If the movement information exceeds the critical value, the controller moves the fingerboard according to the movement direction and speed of the fingerboard display apparatus (500).

Although the slur operation is omitted in the drawings, it can be determined whether the slur button is pressed between steps 200 and 300. If the slur button is pressed, step 300 is performed.

The critical value corresponds to the predetermined movement of the fingerboard display apparatus, which is regarded that the player wants to move the fingerboard. The critical value is preset in the program.

In addition, noise must be removed in order to obtain more precise data from the movement recognition sensor. Such noise can be removed through the filtering process, which is generally known in the art.

Although the present invention relates to the left hand interface, the present invention is not limited thereto. Various right hand interfaces can be combined with the present invention.

1. An apparatus for displaying a fingerboard of a mobile virtual guitar, the apparatus comprising:
a touch screen supporting a multi-touch operation;
a movement recognition sensor; and
a controller that displays the fingerboard on the touch screen and moves the fingerboard based on movement information of the apparatus transmitted from the movement recognition sensor.

2. The apparatus of claim 1, wherein the movement recognition sensor includes an acceleration sensor, the movement information includes a movement of the apparatus in a direction in line with the fingerboard, and the fingerboard is moved according to the movement direction of the apparatus.

3. The apparatus of claim 2, wherein the fingerboard is moved proportionally to a movement speed of the apparatus.

4. The apparatus of claim 2, wherein the fingerboard is moved in the movement direction of the apparatus in a predetermined speed.

5. The apparatus of claim 1, wherein the movement information includes inclination information of the apparatus and the fingerboard is moved based on the inclination information.

6. The apparatus of claim 6, wherein the fingerboard is moved based on an inclined direction of the apparatus proportionally to an inclination degree of the apparatus.

7. The apparatus of claim 5, wherein the fingerboard is moved at a predetermined speed based on an inclined direction of the apparatus.

8. A method for displaying a fingerboard of a mobile virtual guitar in a mobile device having a touch screen supporting a multi-touch operation and a movement recognition sensor, the method comprising:
displaying a part of the fingerboard of the mobile virtual guitar on the touch screen;
receiving a movement recognition signal from the movement recognition sensor;
determining whether the movement recognition signal corresponds to an effective movement of the mobile device; and
moving the fingerboard in a movement direction of the mobile direction if the movement recognition signal corresponds to the effective movement of the mobile device.

9. The method of claim 8, wherein the movement direction and speed of the mobile device are obtained by analyzing the movement recognition signal and the fingerboard is moved corresponding to the movement direction and speed of the mobile device.

10. The method of claim 9, wherein the fingerboard is moved at a constant speed when the speed of the mobile device exceeds a predetermined level.

11. The method of claim 8, wherein an inclination degree of the mobile device is obtained from the movement recognition signal and the fingerboard is moved based on an inclined direction of the mobile device proportionally to the inclination degree of the mobile device.

12. The method of claim 11, wherein the fingerboard is moved at a constant speed when the inclination degree of the mobile device exceeds a predetermined level.

13. The method of claim 8, wherein the fingerboard is not moved when a touch signal is detected from the fingerboard.

14. The method of claim 13, wherein the fingerboard is moved when a slur button is turned on even if the touch signal is detected from the fingerboard.

15. The method of claim 9, wherein the fingerboard is not moved when a touch signal is detected from the fingerboard.

16. The method of claim 10, wherein the fingerboard is not moved when a touch signal is detected from the fingerboard.

17. The method of claim 11, wherein the fingerboard is not moved when a touch signal is detected from the fingerboard.

18. The method of claim 12, wherein the fingerboard is not moved when a touch signal is detected from the fingerboard.
